(19) United States
(12) Patent Application Publication
(10) Pub. No.: US 2024/0405295 A1
(43) Pub. Date: Dec. 5, 2024

(54) Li-Ion Batteries With Increased Electrochemical Stability Window

(71) Applicant: University of Maryland, College Park, College Park, MD (US)

(72) Inventors: Chunsheng WANG, Silver Spring, MD (US); Jijian XU, College Park, MD (US); Xiao JI, College Park, MD (US)

(73) Assignee: University of Maryland, College Park, College Park, MD (US)

(21) Appl. No.: 18/718,028

(22) PCT Filed: Dec. 16, 2022
(86) PCT No.: PCT/US22/53268

§ 371 Date: Jun. 8, 2024

Related U.S. Application Data
(60) Provisional application No. 63/265,767, filed on Dec. 20, 2021.

(51) Int. Cl. H01M 10/26; H01M 10/0525

(52) U.S. Cl. CPC H01M 10/26; H01M 10/0525; H01M 2300/0014

(57) ABSTRACT

The present disclosure provides aqueous electrolytes with a lower salt concentration and wider electrochemical stability window compared to water-in-salt electrolytes. The aqueous electrolyte composition of the disclosure comprises an anti-solvent, which reduces the H₂O activity and the amount of H₂O in the Li-ion solvation sheath. In one particular embodiment of the disclosure provides a nonflammable aqueous electrolyte composition for a lithium-ion battery, wherein the aqueous electrolyte composition comprises: an electrolyte salt comprising a lithium salt; water; and an organic component that is miscible with water. In some embodiments, the electrochemical stability window of the aqueous electrolyte composition is greater than 3.0 V and a molality of an electrolyte salt in said aqueous electrolyte composition is about 5 m or less.

### CROSS-REFERENCE TO RELATED APPLICATIONS

This application claims the priority to U.S. Provisional Application No. 63/265,767, filed Dec. 20, 2021, which is hereby incorporated by reference in its entirety.

### STATEMENT REGARDING FEDERALLY FUNDED RESEARCH

This invention was made with government support under DEAR0000389 awarded by the Department of Energy (DOE ARPA-E). The government has certain rights in the invention.

### FIELD

The present disclosure relates to compositions and methods for increasing electrochemical stability in batteries. In some embodiments, compositions and methods of the disclosure provide lithium-ion batteries having an electrochemical stability window of greater than 3.0 V.

### BACKGROUND

Recent “solvent-in-salt” electrolytes, namely “water-in-salt electrolytes (WISE)” for aqueous batteries and “super-concentrated electrolytes” for non-aqueous batteries, are milestone breakthroughs for both aqueous and non-aqueous systems. The large number of salt aggregates (AGG) in “solvent-in-salt” electrolytes enable preferential salt decomposition over solvent to form robust interphase layers on electrodes, thus greatly expanding the electrochemical window. Unfortunately, the high salt concentration itself inevitably also drive up the viscosity and cost of the electrolytes.

To reduce the amount of salt used, some have resorted to adding an anti-solvent to the electrolyte composition. Typically, the anti-solvent is selected such that it dissolves (e.g., miscible with) solvent but does not dissolve salts. Without being bound by any theory, it is believed that adding an anti-solvent to super-concentrated non-aqueous electrolytes leads to formation of a “localized high concentration electrolytes.” These localized high concentration electrolytes inherit almost all the merits of super-concentrated electrolytes with low viscosity and cost because the anti-solvent maintains the low amount of solvent in Li-ion solvation sheath and high salt AGG. However, adding anti-solvents that does not dissolve lithium-ion also reduce lithium-ion conductivity.

Extensive research has also been carried out for water-in-salt electrolytes to expand the electrochemical stability window. Various methods have been utilized in an attempt to increase the electrochemical stability window of aqueous lithium electrolytes, for example, (i) reducing H₂O molecules in Li-ion solvation sheath through increasing the salt concentration to 27.7 m in hydrate melt electrolyte; (ii) producing 28 m “water-in-bisalt” electrolytes by adding additives; (iii) producing 40 m electrolyte using mixed cation electrolytes; (iv) utilizing 55.5 m lithium-salt monohydrate; and (v) adding an ionic-liquid to WISE to produce 63 m electrolyte.

Using 63 m electrolytes in batteries is costly as these electrolytes require addition of an ionic-liquid as well as a large amount of electrolyte salt. Moreover, even when the electrolyte having 63 m salt concentration is used, the cathodic potential of the WISE is expanded or reduced only to 1.75 V with an overall electrochemical stability window of 3.25 V. Alternative method of reducing the amount of water in WISE is to add organic solvents or gel polymers that are capable of dissolving a large amount of both salt and solvent. Unfortunately, these organic solvents and gel polymers are also flammable, which compromises the merit of aqueous electrolytes. The anti-solvents (e.g., HFE, TTE, TFEO) that are used in non-aqueous electrolytes for “localized high concentration electrolytes” cannot be used in aqueous electrolytes because these anti-solvents are completely (i.e., greater than 90%, or alternatively greater than 92.5%, typically greater than 95%, or alternatively greater than 97.5%, often greater than 99%, or alternatively greater than 99.25%, and most often greater than 99.5%) immiscible with WISE. Thus, conventional methods for increasing the electrochemical stability window are (i) expensive, (ii) result in flammable compositions, and/or (iii) use organic solvents that are immiscible with water.

Accordingly, there is a continuing need for a method for increasing the electrochemical stability window of an aqueous electrolyte composition that reduces the amount of water molecules within lithium-ion solvation sheath in an aqueous electrolyte composition while maintaining nonflammable characteristics of aqueous lithium-ion electrolyte compositions.

### BRIEF SUMMARY

To date, further depletion of water molecules within Li-ion solvation sheath via super-concentration strategy while maintaining nonflammable characteristics of aqueous lithium-ion electrolyte compositions has not been achieved because, at least in part, due to the limit of lithium salts precipitation/dissolution equilibrium.

The present inventors have discovered that by adding a particular class of anti-solvent, one can readily produce dilute aqueous electrolytes beyond WISE that possess wider electrochemical stability window and lower cost, but still maintain the non-flammability. In general, compositions and methods of the disclosure provide one or more of the following advantages compared to conventional methods: (i) adding the anti-solvent disclosed herein results in aqueous electrolytes of the disclosure that possess salt-like characteristics including strong bonding with H₂O molecules to reduce the activity of water and/or remove water from Li-ion solvation sheath; (ii) adding the anti-solvent disclosed herein increases capability to form a robust SEI, thereby reducing the cathodic limiting potential to about 1.5 V or less (e.g., for Li₄Ti₅O₁₂ anodes); and/or (iii) anti-solvent is capable of dissolving lithium salt in a small amount, in this way, to be fully miscible with WISE but can reduce the overall salt concentration, enabling electrolytes to have high ionic conductivity >10⁻³ S/cm and low viscosity. Moreover, typically the anti-solvents or diluents used in the disclosure are cheap and nonflammable, thereby maintaining nonflammability of the electrolytes.

As used herein, the term “capable of dissolving lithium salt in a small amount” means lithium-ion has a solubility of about 1.0 g/L or less, or alternatively about 0.9 g/L or less, or alternatively about 0.8 g/L or less, or alternatively about 0.7 g/L or less, or alternatively about 0.6 g/L or less, typically about 0.5 g/L or less, or alternatively about 0.4 g/L or less, or alternatively about 0.3 g/L or less, often 0.25 g/L or less, or alternatively about 0.2 g/L or less, or alternatively about 0.15 g/L or less, and often 0.1 g/L or less in the anti-solvent of the disclosure. The term “anti-solvent” is used to describe an additive that is added to an aqueous solution of lithium-ion electrolyte that is miscible with water but does not dissolve lithium salt or lithium-ion, i.e., having lithium salt or lithium-ion solubility of about 0.5 g/L or less, or alternatively about 0.4 g/L or less, or alternatively about 0.3 g/L or less, typically about 0.25 g/L or less, or alternatively about 0.2 g/L or less, or alternatively about 0.15 g/L or less, often 0.1 g/L or less, or alternatively about 0.075 g/L or less, or alternatively about 0.05 g/L or less, or alternatively about 0.025 g/L or less, or alternatively about 0.015 g/L or less, and often 0.01 g/L or less. The term “miscible” means the anti-solvent has a solubility in water of at least about 1 g/L, typically at least about 10 g/L, often at least about 100 g/L, and most often at least about 500 g/L.

One particular aspect of the disclosure provides an aqueous electrolyte composition for a lithium-ion battery comprising: an electrolyte salt comprising a lithium salt; water; and an organic compound that is miscible with water as an anti-solvent.

In some embodiments, the organic compound is a protic compound. In other embodiments, the organic compound is an amide. Still in other embodiments, the organic compound is of the formula:

R¹—C(═O)—NR²R³ I

wherein
R¹ is C₁-C₄ alkyl, C₃-C₆ cycloalkyl, or a moiety of the formula —X;
X is —OR^{a}, —NR^{b}R^{c}, or —SR^{a};
each of R^{a} is H or C₁-C₄ alkyl; and
each of R^{b}, R^{c}, R², and R³ is independently H or C₁-C₄ alkyl.

Yet in other embodiments, said lithium salt comprises LiCl, LiPF₆, Li₂SO₄, LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F)₂, LiN(SO₂F)(SO₂CF₃), LiNO₃, LiBF₄, LiCF₃SO₃, or a combination thereof. In one particular embodiment, said lithium salt comprises LiN(SO₂CF₃)₂. Still in another particular embodiment, said lithium salt comprises LiPF₆, LiSO₃CF₃, or a combination thereof.

In other embodiments, said electrolyte salt further comprises a magnesium salt. Exemplary magnesium salts that can be used as electrolytes of the disclosure include, but are not limited to, MgSO₄, MgCl₂, Mg(NO₃)₂, other magnesium salts known to one of ordinary skill, and a combination thereof.

Still in other embodiments, a molality of said electrolyte salt ranges from about 6 m to about 5.75, or alternatively from about 5.75 m to about 5.5 m, or alternatively from about 5.5 m to about 5.25 m, or alternatively from about 5.25 m to about 5.0 m, or alternatively from about 5.0 m to about 4.75 m, or alternatively from about 4.75 m to about 4.5 m, or alternatively from about 4.5 m to about 4.25 m, or alternatively from about 4.25 m to about 4.0 m, or alternatively is about 4.0 m or less. In one particular embodiment, the molality of said electrolyte salt is about 4.5 m.

Yet in other embodiments, said aqueous electrolyte composition is nonflammable.

Other aspects of the disclosure provide a rechargeable lithium-ion battery comprising: a cathode; an anode; and an electrolyte composition disclosed herein, e.g., an electrolyte that comprises an electrolyte salt, water, and another compound that is miscible with water as an anti-solvent. As used herein, the terms “disclosed herein,” “defined herein,” and “described herein” when referring to a variable, a composition, or a method are used interchangeably herein and incorporates by reference the broad definition as well as narrower definition(s), if any. Thus, for example, a battery including an electrolyte salt “disclosed herein” means (i) a battery that includes a lithium salt as an electrolyte; (ii) a battery that includes LiCl, LiPF₆, Li₂SO₄, LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F)₂, LiN(SO₂F)(SO₂CF₃), LiNO₃, LiBF₄, LiCF₃SO₃, or a combination thereof; (iii) a battery that includes LiN(SO₂CF₃)₂; and (iv) a battery that includes LiPF₆, LiSO₃CF₃, or a combination thereof.

In some embodiments, the amount of anti-solvent present in the aqueous electrolyte composition of the disclosure ranges from 5:1 to 5.5:1, or alternatively from 5.5:1 to 6:1, or alternatively from 6:1 to 6.5:1, or alternatively from 6.5:1 to 7:1, or alternatively from 7:1 to 7.5:1, or alternatively from 7.5:1 to 8:1, or alternatively from 8:1 to 8.5:1, or from 8.5:1 to 9:1, or at least about 9:1 v/v relative to the amount of water.

In some embodiments, an electrochemical stability window of said electrolyte composition of the lithium-ion battery is at least about 3.0 V, or alternatively between about 3.0 V and about 3.1 V, or alternatively between about 3.1 V and about 3.2 V, or alternatively between about 3.2 V and about 3.3 V, or alternatively between about 3.3 V and about 3.4 V, or alternatively greater than about 3.3 V. When referring to a numerical value, the terms “about” and “approximately” are used interchangeably herein and refer to being within an acceptable error range for the particular value as determined by one of ordinary skill in the art. Such a value determination will depend at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean ±20%, typically ±10%, often ±5% and more often ±1% of the numerical value. In general, however, where particular values are described in the application and claims, unless otherwise stated, the term “about” means within an acceptable error range for the particular value, typically within one standard deviation.

Still in other embodiments, said aqueous electrolyte composition further comprises a hydroxide. Exemplary hydroxides that can be used in aqueous electrolyte compositions of the disclosure include, but are not limited to, KOH, NaOH, LiOH, as well as any other alkaline hydroxides, alkaline earth hydroxides, and transition metal hydroxides known to one of ordinary skill in the art, as well as a mixture thereof.

Yet in other embodiments, a molality of said electrolyte salt in said electrolyte composition is those defined herein. In one particular embodiment, the molality of said electrolyte salt in said electrolyte composition is less than about 5 m.

In other embodiments, said rechargeable lithium-ion battery is a pouch cell lithium-ion battery or coin cell lithium-ion battery.

In further embodiments, a coulombic efficiency of said rechargeable lithium-ion battery is at least about 85%, typically at least about 90%, often at least about 95%, more often at least about 99%, most often greater than 99%, or alternatively between about 99.90% and about 99.92%, or alternatively between about 99.92% and about 99.94%, or alternatively between about 99.94% and about 99.96%, or alternatively between about 99.96% and about 99.98%, or greater than about 99.98% after 5 cycles.

Still yet in other embodiments, the capacity retention of said rechargeable lithium-ion battery after 500 cycle is between about 60% and 65%, or alternatively between about 65% and 70%, or alternatively between about 70% and 75%, or alternatively between about 75% and 80%, or alternatively between about 80% and 85%, or alternatively between about 85% and 90%, or alternatively between about 90% and 95%, or alternatively at least about 95%. In one particular embodiment, the capacity retention of said rechargeable lithium-ion battery after 500 cycle is at least about 90%.

Yet other aspects of the disclosure provide a rechargeable lithium-ion battery comprising a cathode, an anode, and an aqueous electrolyte composition having an electrochemical stability window described herein (e.g., greater than 3.0 V) and a molality of an electrolyte salt in said aqueous electrolyte composition described herein (e.g., less than 5 m).

In some embodiments, the aqueous electrolyte composition comprises a lithium electrolyte salt, water, and an anti-solvent that is miscible with water. In some instances, the anti-solvent is an organic compound, and yet the electrolyte composition is nonflammable.

Still in other embodiments, said anti-solvent reduces cathodic limiting potential by from about 0.01 V to about 0.05 V, or alternatively from about 0.05 V to about 0.10 V, or alternatively from about 0.10 V to about 0.15 V, or alternatively from about 0.15 V to about 0.20 V, or alternatively by at least about 0.2 V.

Yet in other embodiments, said anti-solvent comprises an amide compound. Exemplary amide compounds that can be used as anti-solvent include, but are not limited to, urea; N-methyl acetamide; acetamide; N,N-Diethylmethacrylamide; N,N-Dimethylacrylamide; tetramethylurea; N,N′-Dimethylurea; 1,1-Dimethylurea; 1,3-Diethylurea; 1,1-Diethylurea; as well as other derivatives thereof; and a combination thereof.

In further embodiments, said aqueous electrolyte composition further comprises a hydroxide. Exemplary hydroxides that can be used in aqueous electrolyte compositions of the disclosure are described above.

Further aspects of the disclosure provide a method for increasing an electrochemical stability window in a lithium-ion battery comprising an aqueous lithium electrolyte solution. The method includes adding an anti-solvent that is miscible with water. In some embodiments, the anti-solvent comprises an amide compound. In one particular embodiment, said amide compound comprises those described herein, for example, urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

Yet in other embodiments, said amide compound is compound of Formula I.

Still in other embodiments, an amount of said electrochemical stability window is increased by from about 0.01 V to about 0.05 V, or alternatively from about 0.05 V to about 0.10 V, or alternatively from about 0.10 V to about 0.15 V, or alternatively from about 0.15 V to about 0.20 V, or alternatively from about 0.20 V to about 0.25 V, or alternatively from about 0.25 V to about 0.30 V, or alternatively from about 0.30 V to about 0.35 V, or alternatively from about 0.35 V to about 0.40 V, or alternatively from about 0.40 V to about 0.45 V, or alternatively from about 0.45 V to about 0.50 V, or alternatively by at least about 0.5 V.

Other aspects of the disclosure provide a method for reducing cathodic limiting potential in a lithium battery comprising an aqueous lithium electrolyte solution, said method comprising adding an anti-solvent that is miscible with water. In some embodiments, said anti-solvent comprises an amide compound. Still in other embodiments, stoichiometric amount of anti-solvent added relative to the amount of water added is from about 1.5 to about 1.25, or alternatively from about 1.25 to about 1.1, or alternatively from about 1.1 to about 1.0, or alternatively about 1 or less. Yet in other embodiments, said amide compound comprises those described herein, for example, urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

In further embodiments, said amide compound is compound of Formula I.

Still in other embodiments, an amount of cathodic limiting potential is reduced by at least about 0.1 V.

It should be appreciated that throughout this disclosure combinations of different or alternative embodiments described herein form other embodiments. For example, one particular method of disclosure for increasing the electrochemical stability is described herein as having the amount of electrochemical stability window increase in the range of from about 0.05 V to about 0.10 V and the stoichiometric amount of anti-solvent added is in the range of from about 1.25 to about 1.1 relative to the amount of water. Thus, a combination of these two different alternative embodiments provides a method for increasing an electrochemical stability window in the range of from about 0.05 V to about 0.10 V by adding the amount of anti-solvent in the range of from about 1.25 to about 1.1 relative to the amount of water. In this manner, a wide variety of different embodiments of compositions and methods are embodied within the present disclosure.

### BRIEF DESCRIPTION OF THE DRAWINGS

FIG. 1 shows a liquid region in ternary phase diagram of urea, LiTFSI, and H₂O at room temperature.

FIG. 2 is a graph showing coordination numbers of CO(NH₂)₂, TFSI, and H₂O around Li⁺ (within 3.0 Å) for 4.1 m, 4.5 m, 5.1 m electrolytes compared with 21 m WISE.

FIG. 3A is a graph showing pair distribution function (g(r)) and coordination number (n(r)) for 4.1 m CO(NH₂)₂-LiTFSI-H₂O-0.1 m KOH electrolyte solution.

FIG. 3B is a graph showing pair distribution function (g(r)) and coordination number (n(r)) for 4.5 m CO(NH₂)₂-LiTFSI-H₂O-0.1 m KOH electrolyte solution.

FIG. 3C is a graph showing pair distribution function (g(r)) and coordination number (n(r)) for 5.1 m CO(NH₂)₂-LiTFSI-H₂O-0.1 m KOH electrolyte solution.

FIG. 4 shows (i) predicted reduction potential (V vs Li/Li⁺) via quantum chemistry calculations and (ii) a graph showing the overall electrochemical stability window of the electrolytes with different LiTFSI concentrations and redox of electrodes overlaid with CV on current collectors, as well as the enlarged views of the regions near cathodic extremes and anodic extremes.

FIG. 5A is a graph showing the cathodic limit of different aqueous electrolytes measured by LSV at a scan rate of 0.2 mV/s.

FIG. 5B is a graph showing the anodic limit of different aqueous electrolytes measured by LSV at a scan rate of 0.2 mV/s.

FIG. 6 is a cyclic voltammogram of aluminum working electrode in the 4.5 m electrolyte (scan rate=1 mV/s) with Pt as a counter electrode, and Ag/AgCl as a reference electrode.

FIG. 7 is a schematic illustration of one possible mechanism for the formation of the inorganic/organic-mixed SEI.

FIG. 8A shows capacity as a function of cycles of 2.5 V LiMn₂O₄∥Li₄Ti₅O₁₂ and 2.6 V LiVPO₄F∥Li₄Ti₅O₁₂ full cells at different lithium salt concentrations.

FIG. 8B shows Coulombic efficiency as a function of cycles of 2.5 V LiMn₂O₄∥Li₄Ti₅O₁₂ and 2.6 V LiVPO₄F∥Li₄Ti₅O₁₂ full cells at different lithium salt concentrations.

FIG. 8C shows the long-term cycling stability of LiMn₂O₄∥Li₄Ti₅O₁₂ full cells in 4.5 m electrolyte at a high current of 0.5 C.

FIG. 8D shows the long-term voltage profile of LiMn₂O₄∥Li₄Ti₅O₁₂ full cell in 4.5 m electrolyte at 0.5 C.

FIG. 9A shows the long-term cycling performance profiles of 1.5 mAh/cm² LMO/LTO full cells in 4.5 m LiTFSI/NMA/H₂O at 0.5 C.

FIG. 9B shows the long-term voltage profiles of 1.5 mAh/cm² LMO/LTO full cells in 4.5 m LiTFSI/NMA/H₂O at 0.5 C.

FIG. 10 shows cycle performance of LiVPO₄F∥Li₄Ti₅O₁₂ full cell in 4.5 m electrolyte at 0.2 C with the areal capacity of 1.5 mAh/cm².

FIG. 11A shows the long-term cycling performance profile of LiVPO₄F∥Li₄Ti₅O₁₂ full cell in 4.5 m electrolyte at 0.5 C.

FIG. 11B shows the long-term voltage profile of LiVPO₄F∥Li₄Ti₅O₁₂ full cell in 4.5 m electrolyte at 0.5 C.

FIG. 12 shows the electrolyte stability window of the electrolyte of the present disclosure compared to various aqueous electrolytes with different salt concentrations (traditional aqueous electrolyte, 21 m, 28 m, and 63 m).

### DESCRIPTION

Some aspects of the disclosure are directed to an aqueous electrolyte composition comprising a nonflammable anti-solvent. In particular, addition of the anti-solvent (sometimes referred to as diluent or additive) of the disclosure (i) results in aqueous electrolytes that possess salt-like characteristics including strong bonding with H₂O molecules to reduce the activity of water and/or remove water from Li-ion solvation sheath; (ii) increases capability to form a robust SEI, thereby reducing the cathodic limiting potential (e.g., to about 1.7 V or less, in some embodiments to about 1.6 V or less, and in other embodiments to about 1.5 V or less); and/or (iii) enables electrolytes to have high ionic conductivity >10⁻³ S/cm and low viscosity. Moreover, because typical anti-solvents used in the disclosure are cheap and nonflammable, the cost remains relatively the same and the electrolyte maintains nonflammability. In some particular embodiments, the anti-solvent is salt-like. As used herein, the term “salt-like” refers to the anti-solvent that is a solid at room temperature but dissolves or is miscible with water.

Various features and advantages of the present disclosure will be illustrated using some of the particular electrolyte compositions. It should be appreciated, however, the scope of the disclosure is not limited to these particular electrolyte compositions. In fact, as explicitly disclosed herein, a wide variety of electrolyte compositions are embodied within the scope of this disclosure. The following discussion regarding various results, features, and advantages are provided merely as illustrative examples and does not constitute limitations on the scope thereof.

Some aspects of the disclosure are based on the discovery by the present inventors that addition of an anti-solvent, in particular, an organic compound as an anti-solvent, to an aqueous electrolyte composition resulted in electrolyte composition having a significantly increased or expanded electrochemical stability window. In some embodiments, an electrochemical stability window of the lithium-ion battery comprising an electrolyte composition of the disclosure is at least about 3.0 V, or alternatively from about 3.0 V to about 3.1 V, or alternatively from about 3.1 V to about 3.2 V, or alternatively from about 3.2 V to about 3.3 V, or alternatively from about 3.3 V to about 3.4 V, or alternatively greater than about 3.3 V.

To determine the effect of adding an anti-solvent of the disclosure, an aqueous electrolyte composition comprising 4.5 m LiTFSI-0.1 m KOH—CO(NH₂)₂—H₂O was prepared and examined. Adding an organic compound as an anti-solvent resulted in an electrolyte composition with expanded electrochemical stability window of 3.3 V. Alternatively, adding an anti-solvent of the disclosure resulted in an increase in the electrochemical stability window by at least about 0.2 V, in other embodiments by at least about 0.3 V, still in other embodiments by at least about 0.4 V, and yet in other embodiments by at least about 0.5 V compared to the same electrolyte composition in the absence of the anti-solvent of the present disclosure.

Yet in other embodiments, addition of the anti-solvent of the disclosure reduced the cathodic limiting potential to from about 1.7 V to about 1.6 V, or alternatively from about 1.6 V to 1.5 V, or alternatively about 1.5 V or less. Alternatively, addition of the anti-solvent of the disclosure resulted in the cathodic limiting potential reduction of from about 0.01 V to about 0.05 V, or alternatively from about 0.05 V to about 0.10 V, or alternatively from about 0.10 V to about 0.15 V, or alternatively from about 0.15 V to about 0.20 V, or alternatively from about 0.20 V to about 0.25 V, or alternatively from about 0.25 V to about 0.30 V, or alternatively from about 0.30 V to about 0.35 V, or alternatively from about 0.35 V to about 0.40 V, or alternatively from about 0.40 V to about 0.45 V, or alternatively from about 0.45 V to about 0.50 V, or alternatively by at least about 0.5 V relative to the same electrolyte composition in the absence of the anti-solvent of the present disclosure.

Still in other embodiments, a detailed study showed addition of the anti-solvent reduced the number of H₂O in Li⁺-solvation shell from 2.6 in WISE to about 2.0 or less, typically to about 1.5 or less, often to about 1.0 or less, and most often to about 0.7 or less. Alternatively, addition of the anti-solvent of the disclosure resulted in reduction of the number of water molecule in Li⁺-solvation shell by from about 10% to about 15%, or alternatively from about 15% to 20%, or alternatively from about 20% to 25%, or alternatively from about 25% to 30%, or alternatively from about 30% to 35%, or alternatively from about 35% to 40%, or alternatively from about 40% to 45%, or alternatively from about 45% to 50%, or alternatively from about 50% to 55%, or alternatively from about 55% to 60%, or alternatively from about 60% to 65%, or alternatively from about 65% to 70%, or alternatively from about 70% to 75%, or alternatively by at least about 75%.

It should be appreciated that throughout this disclosure, when comparing characteristics of WISE and electrolyte compositions of the disclosure, the following concentrations of electrolyte salts are used. Typically, the concentration (i.e., molality) of electrolyte salts in WISE is from about 15.7 m to about 16 m, or alternatively from about 16 m to about 17 m, or alternatively from about 17 m to about 18 m, or alternatively from about 18 m to about 19 m, or alternatively from about 19 m to about 20 m, or alternatively from about 20 m to about 22 m, or alternatively from about 12 m to about 25 m, or at least about 25 m. In contrast, the concentration of electrolyte salts in electrolyte compositions of the disclosure is between about 6 m and about 5.5 m, or alternatively between about 5.5 m and 5.0 m, or alternatively between about 5.0 m and 4.5 m, or alternatively about 4.5 m or less.

Aqueous electrolyte composition of the disclosure comprising 4.5 m LiTFSI-0.1 m KOH—CO(NH₂)₂—H₂O also stabilized water and formed a robust LiF/polymer bilayer solid-electrolyte interface (“SEI”) from the reduction of both LiTFSI and CO(NH₂)₂, while KOH catalyzed the LiTFSI reduction. Moreover, the 2.5 V aqueous LiMn₂O₄∥Li₄Ti₅O₁₂ full cell demonstrated a high Coulombic efficiency (99.9%) and excellent stability (>87% over 1000 cycles) without any pre-treatment.

Solvation structure of 4.5 m LiTFSI-0.1 m KOH—CO(NH₂)—H₂O electrolytes: Salt-like diluents including urea and N-methyl acetamide can strongly bond to water without significantly increasing viscosity. Amides can also reduce the water activity through formation of a strong hydrogen bond to H₂O. It has been reported that the hydrogen bond between an amide and water is even stronger than the hydrogen bond between H₂O molecules. Moreover, amides can also promote the formation of robust SEI layer in aqueous electrolyte and reduce the electrolyte viscosity.

Many amides are green chemicals, low cost, and nonflammable. Moreover, amides such as urea form eutectic systems with both solid LiTFSI salt and liquid H₂O solvent. To study the effect of adding an anti-solvent, urea was selected as a representative of nonflammable anti-solvent or diluent. In particular, urea was added to WISE forming a dilute aqueous electrolyte having a wider electrochemical stability window. It should be appreciated that since a significantly lower amount of electrolyte salt is required when adding an anti-solvent, the cost of resulting electrolyte composition is significantly lower compared to WISE.

Because the phase diagram of ternary CO(NH₂)₂-LiTFSI-H₂O system is unknown, the liquid region in the ternary phase diagram of CO(NH₂)₂-LiTFSI-H₂O was first determined. FIG. 1 (shaded area). Homogenous and clear solutions can be obtained when CO(NH₂)₂-LiTFSI-H₂O compositions are in the shaded region. For example, mixing solid urea and solid LiTFSI with small amount of liquid H₂O at room temperature produced 4.5 m LiTFSI-0.1 m KOH—CO(NH₂)₂—H₂O clear, homogeneous, and transparent aqueous electrolyte solution suggesting strong intermolecular interactions. Based on the ionic conductivity of the aqueous electrolyte, 4.1 m electrolyte in ternary coordinate system was initially selected; however, to further study the electrochemical stability window of the aqueous electrolyte, the content of LiTFSI was increased to 4.5 m and 5.1 m. Table 1 below summarizes the compositions of selected CO(NH₂)₂-LiTFSI-H₂O-0.1 m KOH electrolytes with different LiTFSI salt molality of 4.1 m, 4.5 m, 5.1 m (denoted as 4.1 m, 4.5 m, 5.1 m, respectively). 0.1 m KOH was added in these three electrolytes because KOH can promote the reduction of LiTFSI forming LiF SEI. The individual CO(NH₂)₂ and H₂O, CO(NH₂)₂—H₂O (0.4:1) eutectic electrolyte, and 21 m WISE were used as references.

TABLE 1
Compositions of different electrolytes at 25° C.

| Sample | Salt | Solvent (v/v) | Additives |
|---|---|---|---|
| 21 m WISE | 21 m LiTFSI | H₂O | — |
| CO(NH₂)₂/H₂O | — | 0.4:1 | — |
| | | CO(NH₂)₂:H₂O | |
| 5.1 m | 5.1 m LiTFSI | 7.6:1 | 0.1 m KOH |
| | | CO(NH₂)₂:H₂O | |
| 4.5 m | 4.5 m LiTFSI | 8.6:1 | 0.1 m KOH |
| | | CO(NH₂)₂:H₂O | |
| 4.1 m | 4.1 m LiTFSI | 9.6:1 | 0.1 m KOH |
| | | CO(NH₂)₂:H₂O | |

The intermolecular interactions among LiTFSI, CO(NH₂)₂, and H₂O were investigated by vibrational analysis. The Raman spectra of 4.1 m, 4.5 m, 5.1 m and eutectic CO(NH₂)₂—H₂O aqueous electrolytes along with those of individual CO(NH₂)₂ and H₂O were obtained. The Raman spectrum of pure CO(NH₂)₂ is used as a reference spectrum, which is in accordance with data in the literature. The intense Raman band at 1010 cm⁻¹ in CO(NH₂)₂, corresponding to the symmetrical CN stretching vibration, shifted to a lower wavenumber of 1006 cm⁻¹ in three CO(NH₂)₂-LiTFSI-H₂O-0.1 m KOH aqueous electrolytes (4.1 m, 4.5 m, and 5.1 m) and even lower frequency to 1004 cm⁻¹ in eutectic CO(NH₂)₂/H₂O solution. Because of the weakening of intramolecular hydrogen bonds, the CN bond becomes longer, and the corresponding vibration shifts to a lower wavenumber. The strong interaction between H₂O and CO(NH₂)₂ was also reflected by the shift of C═O and NH₂ modes. According to a previous report, the band at 1647 cm⁻¹ mainly reflects NH₂ deformation while the band at a lower frequency (1540 cm⁻¹) has more C═O character. It is believed that both NH₂ deformation and C═O wagging vibrations in the eutectic CO(NH₂)₂—H₂O solution shift to a higher frequency due to the increase in hydrogen bonding strength via CO(NH₂)₂—H₂O intermolecular interaction. An even larger shift occurs in three electrolytes upon the addition of LiTFSI due to the strong interaction of LiTFSI and H₂O. Therefore, both LiTFSI and CO(NH₂)₂ can reduce H₂O activity and stabilize the H₂O.

The strong CO(NH₂)₂—H₂O interactions in 4.1 m, 4.5 m, and 5.1 m electrolytes were also confirmed using Fourier transform infrared spectroscopy (FTIR), which showed two strong bands of CO(NH₂)₂ at 3348 and 3445 cm⁻¹. These two bands correspond to the NH₂ stretching vibrations, and shift to a higher frequency in 4.1 m, 4.5 m, and 5.1 m aqueous electrolytes due to stronger hydrogen bonding. Furthermore, a visible band at ˜3600 cm⁻¹ appeared in three aqueous electrolytes (4.1 m, 4.5 m, and 5.1 m), while H₂O only has a characteristic broadband at 2900-3700 cm⁻¹. This new band was also found in eutectic CO(NH₂)₂/H₂O with higher intensity, suggesting isolated H₂O interacted with CO(NH₂)₂.

The ¹⁷O nuclear magnetic resonance (NMR) spectra were also used to characterize the strong bonding between CO(NH₂)₂ and H₂O. Briefly, the ¹⁷O signal at −1.31 ppm for bulk H₂O is negatively shifted by −0.13 to −1.44 ppm when 50% of CO(NH₂)₂ was added to H₂O forming eutectic solution suggesting extensive interactions between H₂O and CO(NH₂)₂. When 4.1 m, 4.5 m, and 5.1 m of LiTFSI were added as electrolyte salt, the ¹⁷O signal further shifted by −0.48, −0.5, and −0.53, respectively, demonstrating that H₂O interacts with CO(NH₂)₂ stronger than with Li⁺. However, ¹⁷O signal shift with increased salt concentration is small because of the equilibrium of LiTFSI dissociation, which is confirmed by the negligible shift of the characteristic Raman band of TFSI⁻ (744.5 cm⁻¹) as the salt concentration increased. This result indicates that CO(NH₂)₂ can stabilize the H₂O stronger than LiTFSI salt. Therefore, CO(NH₂)₂ can replace LiTFSI to stabilize H₂O, thereby effectively reducing the amount of LiTFSI salt in water.

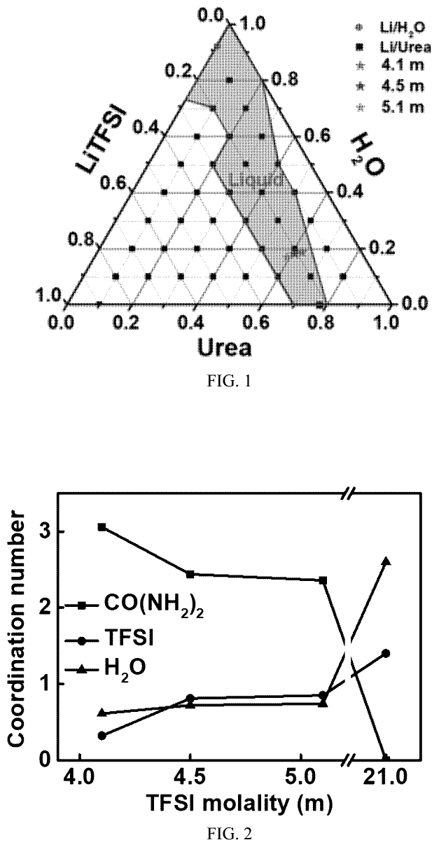

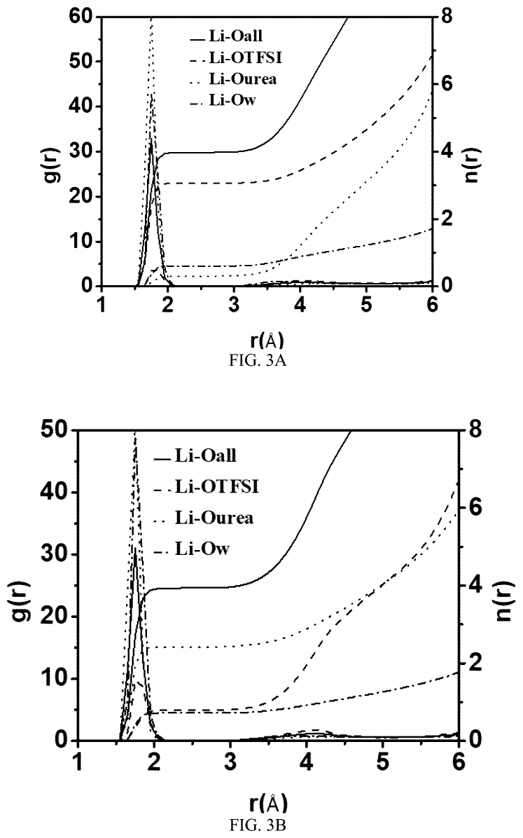

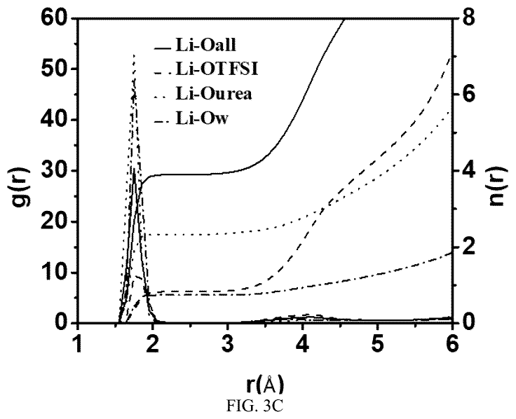

The solvation structures of the electrolytes were simulated using molecular dynamics (MD) as described in the Examples Section infra. MD calculation or simulation showed that introducing CO(NH₂)₂ to the LiTFSI-H₂O electrolyte solution results in changes to the structure of the primary Li⁺-solvation sheath. FIG. 2 summarized the coordination numbers of 4.1 m, 4.5 m, and 5.1 m electrolytes. The detailed pair distribution function and coordination number for 4.1 m, 4.5 m, and 5.1 m electrolytes were studied. See, for example, FIGS. 3A-3C, respectively. In 4.1 m electrolyte, each Li⁺ is on average surrounded by 3.1 molecules of CO(NH₂)₂, 0.3 molecule TFSI, and only 0.6 molecule of H₂O. In contrast, there are on average 2.5 molecules of H₂O in each Li⁺ primary solvation sheath in 21 m WISE. Adding CO(NH₂)₂ results in displacement of some of the water molecules with CO(NH₂)₂ as Li⁺ ion coordinator in the primary solvation shell of lithium ion. This can be spectroscopically observed, e.g., via Raman spectra and FTIR spectra. The average coordination number of TFSI increases as the LiTFSI concentration increases. For example, for 4.5 m electrolyte solution the average coordination number of TFSI is 0.81, and for 5.1 m electrolyte solution the average coordination number of TFSI is 0.85. Thus, an aqueous electrolyte solution of 4.5 LiTFSI corresponds to a [Li(CO(NH₂)₂)_{2.5}(H₂O)_{0.7}(TFSI)_{0.8}] solvation structure. Despite the different LiTFSI concentration, 4.5 m and 5.1 m share almost the same Li⁺ primary solvation structure. In addition, hydrogen bonding can be readily observed in the MD simulations. Hydrogen bonding between CO(NH₂)₂ and H₂O can reduce the H₂O activity by minimizing the presence of interfacial H₂O at the surface of anodes. It is believed this is due to a stronger urea-water hydrogen bonding compared to water-water hydrogen bonding. In addition, a strong hydrogen bonding between urea and water suppresses the H₂O activity by a tighter coordination between urea and water compared to water-water hydrogen bonding. It is believed that this reduction of water activity in turn will lead to an expanded electrochemical stability window.

In some embodiments, the introduction of CO(NH₂)₂ also reduces the amount of aggregates (AGG). Accordingly, in some embodiments a small amount of KOH was added simultaneously with CO(NH₂)₂ to catalyze the reduction of TFSI⁻ to form LiF solid-electrolyte interface (SEI).

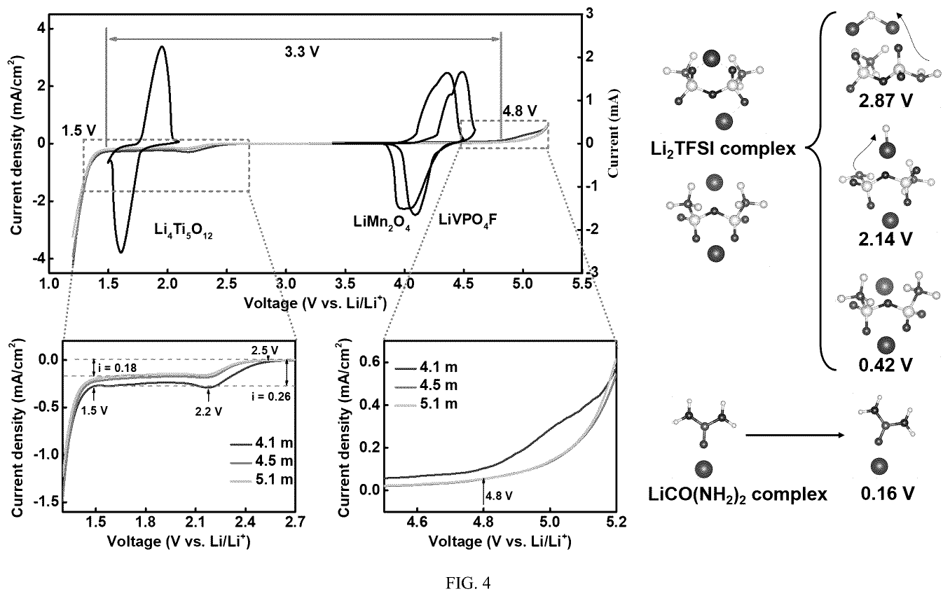

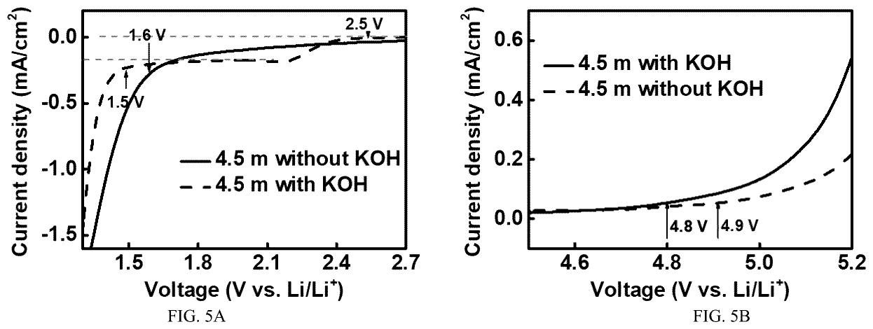

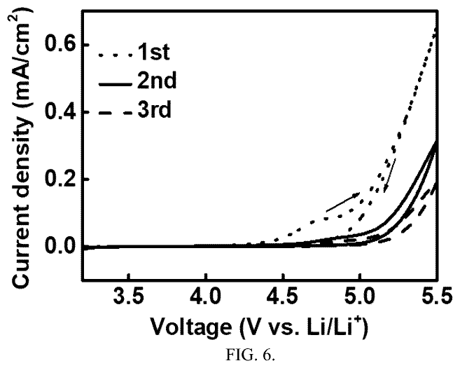

Electrochemical property of 4.5 m LiTFSI-0.1 m KOH—CO(NH₂)₂—H₂O electrolytes: The electrochemical stability windows of 4.1 m, 4.5 m, and 5.1 m aqueous electrolytes were tested by linear sweep voltammetry (LSV) at a scanning rate of 0.2 mV/s (FIG. 4A). As shown in FIG. 4A, the electrolyte stability window extends significantly from 3.0V of WISE to 3.3V and the cathodic potential negatively shifted by 0.4V from 1.9V to 1.5V. FIG. 4B shows that the reduction at all concentrations starts at ˜2.5 V (before the cathodic limit of 2.4 V according to the Pourbaix diagram of water at pH 10) and reaches to a plateau at ˜2.2 V. It has been well acknowledged that the fluorinated lithium salt (LiTFSI) plays an important role in forming a LiF-rich SEI. DFT calculations (FIG. 4D) also demonstrates the reduction potential of LiTFSI is much higher than that of CO(NH₂)₂, suggesting the preferential reduction of LiTFSI over CO(NH₂)₂. KOH further accelerates the reduction kinetics of LiTFSI. The important role of KOH additive is clearly demonstrated in FIGS. 5A and 5B. The small plateau corresponding to the reduction of LiTFSI appears with the existence of KOH, validating that KOH can accelerate the reduction kinetics of LiTFSI and thus generate LiF-rich SEI. As illustrated in above [Li(CO(NH₂)₂)_{2.5}(H₂O)_{0.7}(TFSI)_{0.8}] solvation structure, the great solubilization ability of CO(NH₂)₂ results in interphase chemistry dominated by CO(NH₂)₂ rather than H₂O. Here, a synergistic effect among LiTFSI, CO(NH₂)₂, KOH contributes to a robust SEI layer which successfully pushes the cathodic limit to 1.5 V. It is found that CV curves of 4.5 m and 5.1 m electrolytes are almost overlapped, while the relatively dilute 4.1 m electrolyte shows a slightly large plateau current of 0.26 mA/cm² compared to 0.18 mA/cm² for 4.5 m or 5.1 m electrolytes. Similarly, 4.1 m electrolyte also shows a slightly higher current on the anodic scan (FIG. 4C). 4.5 m aqueous electrolytes show a slightly lower anodic limitation (4.8 V) than that of WISE (4.9 V) due to the CO(NH₂)₂ oxidation reaction. To explore the possible electrolyte corrosion of aluminum, CV with Al foil as working electrode (FIG. 6) and SEM image of Al foil after CV (held at 5.0 V for 3.0 h) were examined. It was observed that corrosion of aluminum by LiTFSI was mostly suppressed. In addition, surprisingly and unexpectedly 4.5 m LiTFSI-0.1 m KOH—CO(NH₂)₂—H₂O aqueous electrolytes provided a widened electrochemical window of 3.3 V.

The cyclic voltammogram (CV) of active electrodes (Li₄Ti₅O₁₂, LiMn₂O₄, and LiVPO₄F) in 4.5 m electrolyte showed the characteristic redox peaks, which were all shifted upward by about 0.2 V due to the Nernst shift, suggesting that the lithium-ion activity in 4.5 m electrolyte was as low as that in 21 m WISE. It is worth noting that Li₄Ti₅O₁₂ anode has fast reaction kinetics and long cycling stability, and as such has been a long-pursued anode for aqueous lithium-ion batteries. However, to date this anode has not been used in aqueous electrolytes because of the “cathodic challenge” (e.g., having a reduction potential ranging from 1.7 V to 1.9 V versus Li). Previous strategies such as using an extremely high concentration (e.g., 63 m with gel passivation or adding PEG in aqueous electrolytes along with Li_{1.3}Al_{0.3}Ti_{1.7}(PO₄)₃ coating on Li₄Ti₅O₁₂) still cannot achieve a desired high Coulombic efficiency (>99.9%) for commercialization of Li₄Ti₅O₁₂ anodes in aqueous Li-ion batteries. To date, no aqueous electrolytes have enabled use of Li₄Ti₅O₁₂ as an anode in aqueous electrolytes with a high Coulombic efficiency (e.g., >99.9%). Table 2 shows LiMn₂O₄∥Li₄Ti₅O₁₂ full cells comprising aqueous electrolytes of the disclosure having a significantly improved Coulombic efficiency with a practical loading of active materials (≥1.5 mAh/cm²) and a low cathode excess (e.g., <20%).

TABLE 2
Comparison of 4.5 m electrolyte with other reported electrolytes
for Li₄Ti₅O₁₂-based aqueous Li-ion batteries

| | | Areal capacity | P/N | Cycle life | |
|---|---|---|---|---|---|
| Electrolyte composition | | (mAh/cm²) | ratio | @ 1 C | Flammability |
| 27.7 | m LiTFSI—BETI | 0.22 | 2 | 200 (75%) | No |
| 2 | m LiTFIS—PEG | 0.25 | 0.6 | 300 (68%) | Low |
| 15.3 | m LiTFSI—CH₃CN | 0.32 | 1.9 | 300 (98%) | Low |
| 63 | m Me₃EtN—LiTFSI | 0.5 | 1.1 | 100 (88%) | No |
| 4.5 | m LiTFSI—KOH—CO(NH₂)₂ | 1.5 | 1.14 | 1000 (88%) | No |
| 4.5 | m LiTFSI—KOH—CO(NH₂)₂ | 2.5 | 1.14 | 500 (72%) | No |

The composition of SEI layers on Li₄Ti₅O₁₂ electrodes after cycling in 4.5 m aqueous electrolytes was characterized using X-ray photoelectron spectroscopy (XPS) and time of flight secondary ion mass spectrometry (ToF-SIMS). The cycled Li₄Ti₅O₁₂ electrodes washed with dimethyl carbonate (DMC) to remove residual electrolytes before XPS analysis. The characteristic C 1s peak located at 284.2 eV derives from conductive carbon as well as CF₃ peak at 293.0 eV comes from PVDF binder in the anode composites. The detected 286.1 eV signal in C 1s, 400.0 eV signal in N 1s, and 232.6 eV signal in O 1s belong to organic C—O—N species derived by CO(NH₂)₂. The presence of a minor amount of Li₂CO₃ as an SEI component is supported by 290.5 eV in C 1s and 530.5 eV in O 1s spectra, respectively. The formation of Li₂CO₃ is attributed to CNO⁻ and then CO₃²⁻ that were formed by the decomposition of CO(NH₂)₂ through nucleophilic attack under alkaline condition. Inorganic LiF is examined by the additional F 1s signal at 685.5 eV, which results from the reduction of LiTFSI. The residual F 1s signal at 688.5 eV can be assigned to the PVDF binder. The XPS patterns of a Li₄Ti₅O₁₂ electrode before cycling were also measured for comparison. No obvious Li₂CO₃ or LiF signal was detected.

The ToF-SIMS spectrum was collected in negative polarity in the 5-60 m/z range. A large number of fragments were observed, for instance, m/z=16 (O⁻) from Li₄Ti₅O₁₂ active material, 19 (F⁻) from the reduction of LiTFSI, 24 (C₂⁻) and 26 (CN⁻) from CO(NH₂)₂ decomposition (CO(NH₂)₂→CNO⁻→CN⁻, C₂⁻), which is consistent with XPS results. No observable Li₂CO₃ derived second ion species was detected, suggesting the amount of Li₂CO₃ is small. Species spatial distribution in SEI on Li₄Ti₅O₁₂ surface was analyzed by depth-profiles of ToF-SIMS, which showed the edge surface of the crater sputtered by Ga⁺ ions with a depth of 1.3 um. According to the concentration depth profiles, CN⁻ and F⁻ concentrations decreased quickly with etching. In contrast, increase in Li₄Ti₅O₁₂ active material derived O⁻ concentration was observed. Closer examination showed that the concentration of LiF related species (F⁻) decrease with a lower concentration gradient than organic species (CN⁻) from the surface to the bulk of the electrode, indicating that organic species are located mainly at the top surface while LiF species are located more deeply in the surface layer. The F⁻ signal intensity in 4.5 m aqueous electrolytes without KOH additive was lower compared with that from the SEI in 4.5 m aqueous electrolytes with KOH additive, which indicates more LiF is generated with KOH additive. In addition, ToF-SIMS results also suggest the formation of F-rich CEI layer on the LiMn₂O₄ cathode side.

The structure of cycled Li₄Ti₅O₁₂ electrodes was also analyzed by high-resolution transmission electron microscopy (HRTEM), further verifying a LiF/polymer bilayer SEI. The polymer/LiF bilayer SEI on cycled Li₄Ti₅O₁₂ surface in 4.5 m electrolyte is different from the crystalline LiF SEI formed on Mo₆S₈ in WISE. Together with the C—O—N species detected in XPS and CN⁻ species detected in ToF-SIMS results, the amorphous characteristic was ascribed to polyurea. Thus, the SEI interphase formed on the Li₄Ti₅O₁₂ anode surface during cycling in 4.5 m electrolyte is a mixture of organic species and inorganic species that mainly comprised LiF.

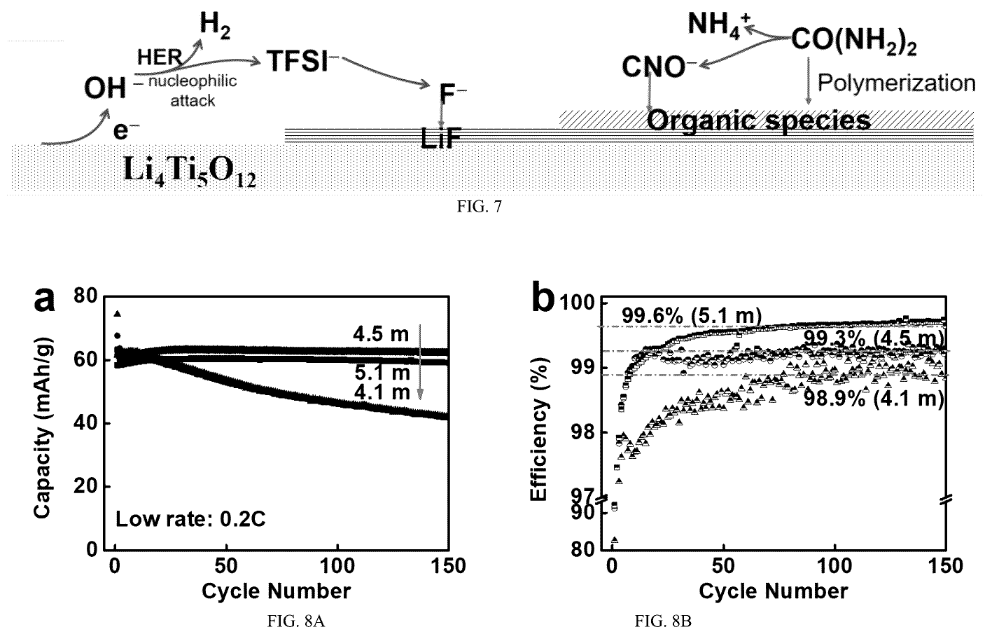

From the SEI composition analysis, one possible mechanism for the SEI formation is summarized in FIG. 7. First, TFSI generates F⁻ anions via a nucleophilic attack in the presence of OH⁻. Under the alkaline condition, F⁻ anions precipitate with Li⁺ cations forming the inner LiF layer at a high potential, while at a low potential, urea electrochemically polymerized into polyurea on the outer-surface of LiF. Such a robust bilayer SEI with LiF-rich inner layer and organic outer layer is beneficial for stable performance.

Electrochemical performance of 2.5V LiMn₂O₄∥Li₄Ti₅O₁₂ and 2.6V LiVPO₄F∥Li₄Ti₅O₁₂ full cells in 4.5 m electrolyte: As shown in FIG. 4 and by structural and chemical analysis of SEI layer, all the redox peaks of LiVPO₄F and LiMn₂O₄ cathodes and Li₄Ti₅O₁₂ anodes are located within the electrochemical stability window of the three aqueous electrolytes (4.1, 4.5 and 5.1 m) and robust SEI was formed on Li₄Ti₅O₁₂ anode surface during charge/discharge cycles. To further study the aqueous electrolytes of the disclosure, Li₄Ti₅O₁₂ anode was paired with either LiMn₂O₄ or LiVPO₄F cathode forming a full cell with a low P/N capacity ratio of 1.14. A slight excess of cathode electrode capacity was used to counteract the irreversible lithium depletion during SEI formation.

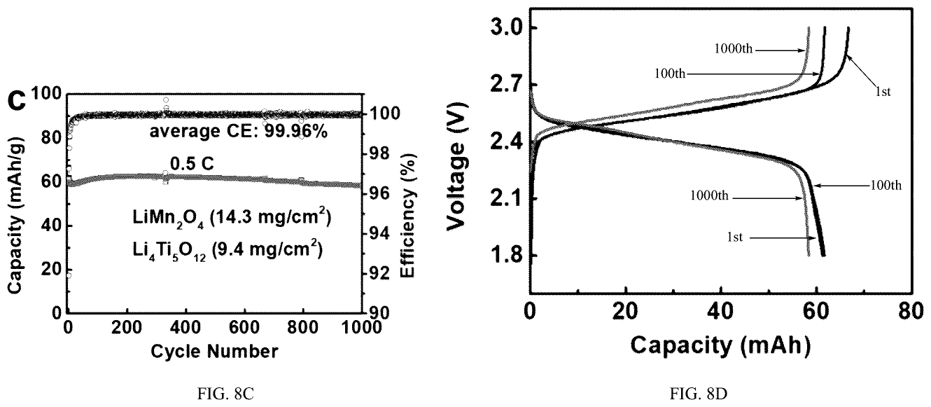

The electrochemical performances of LiMn₂O₄∥Li₄Ti₅O₁₂ full cells were evaluated in aqueous electrolytes with different LiTFSI concentrations, namely, 5.1 m, 4.5 m, and 4.1 m. See FIGS. 8A and B. The Coulombic efficiency at a low rate of 0.2 C was applied to all cells to monitor any side reaction, which is also used in the real battery environment. As shown in FIG. 8A, LiMn₂O₄∥Li₄Ti₅O₁₂ full cells in 5.1 m and 4.5 m electrolytes are relatively stable upon cycling even at 0.2 C and low P/N value, where cell stability in 4.5 is much better than in 4.1 m electrolyte. The slightly lower capacity of the full cell in 5.1 m electrolyte than that in 4.5 m electrolyte is attributed to the higher viscosity caused by the increased salt concentration. Since lithium source is limited in full cells, Coulombic efficiency is important for cycling stability. As shown in FIG. 8B, the Coulombic efficiencies of LiMn₂O₄∥Li₄Ti₅O₁₂ full cells in 4.1 m, 4.5 m and 5.1 m electrolytes are 82.6%, 90.7%, and 92.8%, respectively, in the first cycle. This Coulombic efficiency progressively increased in the subsequent cycles and finally stabilize at 99.0% (4.1 m), 99.7% (4.5 m) and 99.8% (5.1 m).

Among three electrolytes, 4.5 m electrolyte has the best overall properties, i.e., a relatively high ionic conductivity (1.0 mS/cm), a low viscosity (0.32 Pa s), and a wide electrochemical window (3.3 V). According to the thermal analysis of the 4.5 m electrolyte, it remains liquid state and is stable over a wide temperature range. Taking all these physicochemical properties and cost factor into consideration, 4.5 m electrolyte was selected for a more detailed study.

FIG. 8C displays the long-term cycling performance of LiMn₂O₄∥Li₄Ti₅O₁₂ full cells in 4.5 m electrolyte at a high current of 0.5 C. The full cells demonstrate a discharge capacity of 61.3 mAh/g, corresponding to anode capacity of 154.6 mAh/g and cathode capacity of 101.6 mAh/g. The initial Coulombic efficiency is as high as 91.9% due to the formation of highly-insulted LiF-rich SEI. Hydrogen evolution was negligible, or only occurred during the initial cycles and diminished rapidly. The GC-MS of the extracted gas from the cells cycled in 4.5 m aqueous electrolytes after the first cycle verified the generation of H₂, corresponding to the hydrogen evolution reaction during the first cycle. The observed N₂ and CO₂ gas are attributed to the decompose of urea. And Ar is the carrier gas of the instrument. After 20 cycles, the pouch cells were fully degassed and subsequently cycled for another 20 cycles. The GC-MS results indicate there is no H₂ gas detected in the subsequent cycles. The Coulombic efficiencies increase to 99% within 5 cycles and ultimately achieve an average CE of 99.96% after 26 cycles. As expected, a long cyclic life of >1000 is achieved. Impressively, the LiMn₂O₄∥Li₄Ti₅O₁₂ cell retains >87% capacity even after 1000 cycles with a slightly increased polarization. FIG. 8D. In contrast, the LiMn₂O₄∥Li₄Ti₅O₁₂ cells in 4.5 m electrolyte without KOH additive show gradual capacity decay upon cycling.

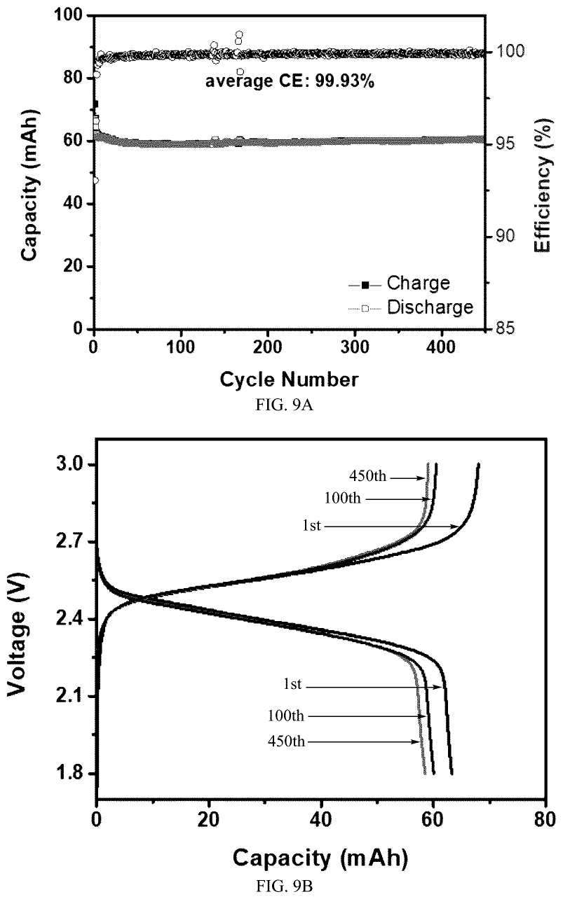

The electrolyte design strategy disclosed herein can be applied to other amides (e.g., urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; as well as combination(s) thereof) with a similar molecular structure. For example, by replacing urea with N-methyl acetamide, the LiMn₂O₄∥Li₄Ti₅O₁₂ full cell also shows excellent stability with high capacity retention (90% with 450 cycles), as shown in FIGS. 9A and 9B.

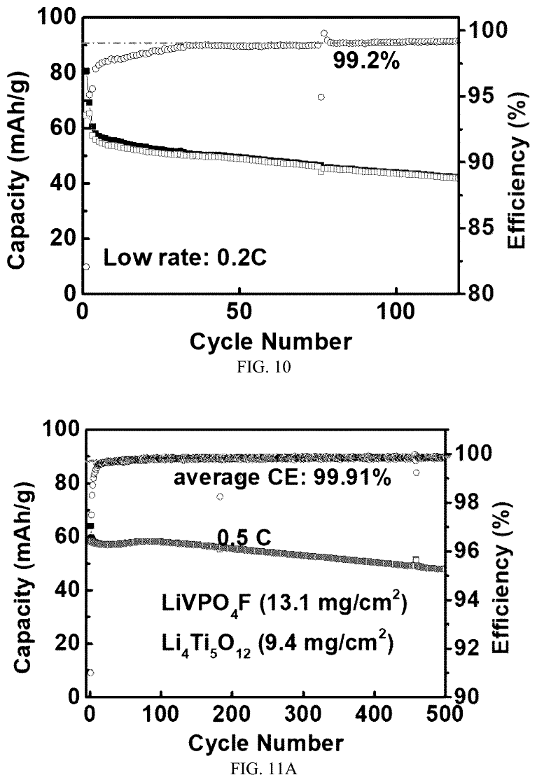

LiVPO₄F can deliver 142 mAh/g at 4.2 V, corresponding to an energy density of 596 Wh/kg, which is 32% of higher than that of LiMn₂O₄. The Coulombic efficiency of LiVPO₄F∥Li₄Ti₅O₁₂ full cells at a low rate of 0.2 C is 82.1% in the first cycle, which gradually increased in the following cycles and finally stabilized at around 99.2%. FIG. 10. The battery performance of 2.6V LiVPO₄F∥Li₄Ti₅O₁₂ full cell at P/N=1.14 was also cycled in 4.5 m aqueous electrolyte at the rate of 0.5 C. FIGS. 11A and 11B. The first charge and discharge capacity is 64.1 mAh/g, and 58.1 mAh/g (of the total mass of LiVPO₄F+Li₄Ti₅O₁₂), respectively, corresponding to the initial Coulombic efficiency of 90.6%. The capacity retention is above 80% after 500 cycles. The LiVPO₄F∥Li₄Ti₅O₁₂ full cells can deliver a higher average voltage of 2.6 V compared to 2.5 V LiMn₂O₄∥Li₄Ti₅O₁₂ full cells. Such a 2.6 V (LiVPO₄F/Li₄Ti₅O₁₂) full cell delivers an energy density of 150.8 Wh/kg (of total electrode mass).

To further evaluate the LiMn₂O₄∥Li₄Ti₅O₁₂ cell, a LiMn₂O₄∥Li₄Ti₅O₁₂ pouch cell with a high areal capacity of 1.5 mAh/cm² and P/N capacity ratio of 1.14 was evaluated. The pouch cell exhibited an average Coulombic efficiency of 99.97% and retained 88% capacity after 1000 cycles at 1 C, which is much better than all aqueous electrolytes reported to date (Table 2). The areal capacity was further increased to 2.5 mAh/cm², which is definitely at the commercial cell level. Typical galvanostatic charge-discharge curves for the LiMn₂O₄∥Li₄Ti₅O₁₂ pouch cells at 1 C with areal capacity of 1.5 and 2.5 mAh/cm² were compared. This comparison indicated a relatively small polarization at higher areal capacity. After electroosmotic wetting at 2.0 V for 12 h and under optimized external pressure (0.5 Mpa), 2.5 mAh/cm² LiMn₂O₄∥Li₄Ti₅O₁₂ pouch cell exhibited a high capacity retention of 72% after 500 cycles. The coulombic efficiency in the first cycle at 1 C is very high (93.6%), and quickly increases to 99.9% in 50 cycles, demonstrating the formed SEI in the first few cycles effectively suppressed the water decomposition. The average CE from 10 to 500 cycles is 99.87%, which is comparable to organic electrolyte LiMn₂O₄∥Li₄Ti₅O₁₂ cells. The initial capacity decay may be attributed to the consumption of Li in LiMn₂O₄ due to the formation of SEI. This capacity decay can be reduced by using Li_{1.5}Mn₂O₄. The low self-discharge rate validates that the 4.5 m aqueous electrolyte enables the formation of stable SEI which successfully suppressed side reactions (H₂O decomposition in particular).

The rate capability of the LiMn₂O₄∥Li₄Ti₅O₁₂ pouch cells at current densities of 1C, 2C, 3C showed reversible capacities of 58.6 (92%), 46.9 (74%), and 34.8 (55%) mAh/g, respectively. Three-electrodes pouch cells were used in distinguishing the voltage and cycling behavior in individual electrodes. Cells composed of Li₄Ti₅O₁₂ anodes, LiMn₂O₄ cathodes, lithiated LiFePO₄ as references, membranes, and 4.5 m aqueous electrolytes, were cycled at 1C for testing. The capacity decay is mainly caused by the loss of active lithium of LiMn₂O₄ cathodes due to the formation of SEI. One method to improve the cycling performance is through using lithium-rich Li_{1.5}Mn₂O₄ as cathodes.

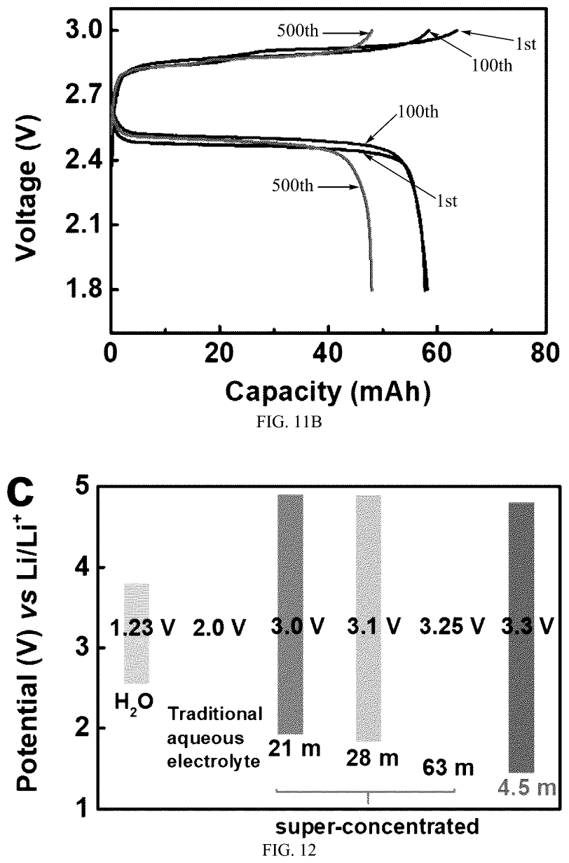

A visual comparison of the electrolyte stability window and salt concentration of typical aqueous electrolytes are presented in FIG. 12. Surprisingly and unexpectedly, electrolytes of the present disclosure achieve an expanded electrochemical stability window of 3.3 V without using super-concentrated salts. Using the electrolyte compositions of the disclosure, an energy density of 103 Wh/kg at the level of an 18650-type cell was readily obtained. This energy density is slightly higher than Ni-MH technology (100 Wh/kg). Taking other factors including voltage, rate capability, environmental friendliness, overall cost, and cycle life into consideration, it is reasonable to expect the electrolytes of the disclosure will outperform current commercial aqueous technologies including lead-acid, Ni—Cd, and Ni-MH batteries.

Beyond 21 m WISE with an electrochemical stability window of 3.0 V, the present disclosure provides aqueous electrolytes comprising an anti-solvent with expanded electrochemical stability window of 3.3 V at a significantly lower electrolyte salt concentration (e.g., an aqueous electrolyte of 4.5 m LiTFSI—KOH—CO(NH₂)₂—H₂O). By adding non-flammable organic anti-solvent, such as an amide, aqueous electrolytes of the disclosure replace some of the LiTFSI and reduce the number of H₂O in Li⁺-solvation shell from 2.6 in WISE to 0.7. It is believed that similar to LiTFSI salt, an amide anti-solvent, such as urea, can suppress the activity of H₂O via strong hydrogen bond interaction with water, subtly substitute the H₂O site in the Li⁺ primary solvation shell and contribute to the formation of robust SEI comprising an organic outer and LiF-rich inner layer. Moreover, aqueous electrolytes of the disclosure, such as 4.5 m LiTFSI—KOH—CO(NH₂)₂—H₂O, enable Li₄Ti₅O₁₂ anode to couple with both LiMn₂O₄ and LiVPO₄F cathodes with a low P/N ratio of 1.14 to achieve high Coulombic efficiency (≥99.9%) and long cycling stability (up to 1000 cycles). Furthermore, a pouch cell of high areal capacity (2.5 mAh/cm²) and a low P/N capacity ratio of 1.14 and superior reversibility over 500 cycles with 72% capacity retention can be produced using the aqueous electrolytes of the disclosure. Accordingly, aqueous electrolytes of the disclosure provide a promising way to expand the electrochemical stability and allow use of aqueous lithium-ion batteries in practical applications where both safety and low cost are crucial.

Additional objects, advantages, and novel features of this disclosure will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### Examples

Molecular Dynamics Simulation: All the molecular dynamic (MD) simulations were performed using the Large-scale Atomic/Molecular Massively Parallel Simulator (LAMMPS, lammps.sandia.gov). To simulate the 4.1 m, 4.5 m and 5.1 m electrolytes, LiTFSI, urea, and water molecules were added to a 50×50×50 Å³ box according to the concentration. The properties of urea were assessed with OPLS-AA parameters and RESP charges. Known force-field parameters of Li⁺ and TFSI⁻ were used. See, for example, Wang et al., Nat. Commun., 7, pp. 1-9 (2016). The systems were setup initially by using PACKMOL and Moltemplate (moltemplate.org). The simulations were started with a 2 ns NPT at 500 K and followed by a 3 ns NPT at 330 K to make sure the full dissolution of the electrolyte. Then, the systems were equilibrated at 298° K and 1 atm in the NPT ensemble for 5 ns with a timestep of 1.0 fs. The NPT calculated densities (298° K) are in good agreement with the experimental measured densities at room temperature, respectively. Finally, a MD run in the NVT ensemble was performed for 10 ns for equilibrium, and a following 10 ns NVT simulation was used to obtain the data. VMD software was used for visualizing the snapshots and analyzing the results.

Quantum Chemistry Calculations: Quantum chemistry (QC) calculations were performed using Gaussian 09 software package to get the reduction potentials. B3LYP density functional and 6-31+G** basis set were used for optimizing the Li⁺-complex structures. SMD implicit solvation model using acetone parameters (∈=20.49) was used for the calculation of Li⁺ complexes. For the solvation energies calculation, the M052X/6-31G* was used since it was studied to be the best average performer for aqueous solvation energies in the original SMD study. See, for example, Xu et al., J. Phys. Chem. A, 123, 7430-7438 (2019). The reduction potentials were calculated using the same method disclosed by Borodin et al., in Nanotechnology, 26, p. 354003 (2015). Visualization of the structures are made by using VESTA software.

Electrode preparation and Electrochemical Measurement: The Li₄Ti₅O₁₂ anode, LiMn₂O₄ and LiVPO₄F cathode electrodes were provided by Saft Corporation. LTO anodes and LMO anodes were coated on an aluminum foil as the current collector with high loadings: 1.5 mAh/cm² for LTO and 1.7 mAh/cm² for LMO. LiVPO₄F (1.7 mAh/cm²), LTO (2.5 mAh/cm²) and LMO (2.8 mAh/cm²) were coated for comparison. After calendering, the LMO cathodes and LTO anodes had porosities of 40% and 30%, respectively. The thickness of LMO increased from 90 μm to 135 μm as loading increased. Similarly, the thickness of LTO was 80 μm for 1.5 mAh/cm² and 95 μm for 2.5 mAh/cm². These electrodes were cut into 1.2 cm² sheets, vacuum-dried at 80° C. for 24 h before assembling. Electrochemical measurements were performed using 2032 coin cells. Whatman glass fiber was used as the separator. As for the pouch cells, aluminum and nickel strips were attached as electrode tabs to the sides of the cathode and anode, respectively. The electrolyte addition for each pouch cell was 0.02 mL/mAh. The electrolyte was injected into the package, followed by sealing of the battery under vacuum. The linear sweep voltammograms (LSV) tests was measured with a three-electrode cell with a Pt working electrode, Pt counter electrode and Ag/AgCl as reference electrode. A CHI660B electrochemical workstation was used for the LSV measurements at a scan rate of 0.2 mV s⁻¹. Galvanostatic cycling of the assembled cells was carried out using a Land CT2001A tester (Wuhan, China).

Ionic conductivity measurement of aqueous electrolytes: The ionic conductivity was measured with electrochemical impedance spectroscopy (EIS) using a Gamry workstation (Gamry 1000E, Gamry Instruments, USA), with a 5-mV perturbation and the frequency is in the range 0.01-100,000 Hz at room temperature. The conductivity cell constants were predetermined using 0.01M aqueous KCl standard solution at room temperature.

Sample Characterization: Raman spectra were collected with a Horiba Jobin Yvon Labram Aramis using a 532 nm diode-pumped solid-state laser between 1200 and 100 cm⁻¹, with all the samples sealed in a test glass tube. The Fourier transform infrared spectroscopy (FTIR) was recorded by NEXUS 670 FT-IR Instrument. ¹⁷O NMR spectra were acquired on a Bruker DRX 500 spectrometer at a ¹⁷O frequency of 67.81 MHz, using chemical shift of ¹⁷O-nuclus in pure water as 0 ppm reference. All NMR measurements were conducted at 296.2 K. X-ray photoelectron spectroscopy (XPS) experiments were carried out on a high resolution Kratos AXIS 165 X-ray photoelectron spectrometer using monochromic Al Ka radiation. All the samples were recovered from full aqueous Li-ion batteries (ALIBs) cell in 2032 coin cell configuration after electrochemical cyclings. The samples were washed by DME three times and then dried under vacuum for two hours before XPS measurement. The morphologies of the samples were observed on a JEOL-JEM 2100F transmission electron microscope (TEM) (100 kV) and a Hitachi SU-70 field emission scanning electron microscope (FE-SEM) (5 kV).

The foregoing discussion of the disclosure has been presented for purposes of illustration and description. The foregoing is not intended to limit the disclosure to the form or forms disclosed herein. Although the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A nonflammable aqueous electrolyte composition for a lithium-ion battery, said nonflammable aqueous electrolyte composition comprising:
an electrolyte salt comprising a lithium salt;
water; and
an organic component that is miscible with water.

2. The aqueous electrolyte composition according to claim 1, wherein said organic compound is an amide.

3. The aqueous electrolyte composition according to claims 1-2, wherein said organic compound is of the formula:
R¹—C(═O)—NR²R³
wherein
R¹ is C₁-C₄ alkyl, C₃-C₆ cycloalkyl, or a moiety of the formula —X;
X is —OR^{a}, —NR^{b}R^{c}, or —SR^{a};
each of R^{a} is H or C₁-C₄ alkyl; and
each of R^{b}, R^{c}, R², and R³ is independently H or C₁-C₄ alkyl.

4. The aqueous electrolyte composition according to claims 1-3, wherein said lithium salt comprises LiCl, LiPF₆, Li₂SO₄, LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F)₂, LiN(SO₂F)(SO₂CF₃), LiNO₃, LiBF₄, LiCF₃SO₃, or a combination thereof.

5. The aqueous electrolyte composition according to claims 1-4, wherein said lithium salt comprises LiN(SO₂CF₃)₂.

6. The aqueous electrolyte composition according to claims 1-5, wherein said lithium salt comprises LiPF₆, LiSO₃CF₃, or a combination thereof.

7. The aqueous electrolyte composition according to claims 1-6, wherein said electrolyte salt further comprises a magnesium salt.

8. The aqueous electrolyte composition according to claims 1-7, wherein a molality of said electrolyte salt is about 6 m or less.

9. The aqueous electrolyte composition according to claims 1-8, wherein the molality of said electrolyte salt is about 5.5 m or less.

10. The aqueous electrolyte composition according to claims 1-9, wherein the molality of said electrolyte salt is less than about 5 m.

11. The aqueous electrolyte composition according to claims 1-10, wherein said organic compound comprises urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

12. A rechargeable lithium-ion battery comprising:
a cathode;
an anode; and
an electrolyte composition comprising an electrolyte salt, water, and another compound that is miscible with water as an anti-solvent.

13. The rechargeable lithium-ion battery according to claim 12, wherein an electrochemical stability window of said electrolyte composition is greater than 3.0 V.

14. The rechargeable lithium-ion battery according to claims 12-13, wherein said aqueous electrolyte composition further comprises a hydroxide.

15. The rechargeable lithium-ion battery according to claims 12-14, wherein said hydroxide comprises KOH, NaOH, LiOH, or a mixture thereof.

16. The rechargeable lithium-ion battery according to claims 12-15, wherein a molality of said electrolyte salt in said electrolyte composition is less than 5 m.

17. The rechargeable lithium-ion battery according to claims 12-16, wherein said rechargeable lithium-ion battery is a pouch cell lithium-ion battery or coin cell lithium-ion battery.

18. The rechargeable lithium-ion battery according to claims 12-17, wherein a coulombic efficiency of said rechargeable lithium-ion battery is 99% or higher after 5 cycles.

19. The rechargeable lithium-ion battery according to claims 12-18, wherein the capacity retention of said rechargeable lithium-ion battery after 500 cycle is at least 90%.

20. A rechargeable lithium-ion battery comprising a cathode, an anode, and an aqueous electrolyte composition having an electrochemical stability window of greater than 3.0 V and a molality of an electrolyte salt in said aqueous electrolyte composition of less than 5 m.

21. The rechargeable lithium-ion battery according to claim 20, wherein said aqueous electrolyte composition comprises a lithium electrolyte salt, water, and an anti-solvent that is miscible with water.

22. The rechargeable lithium-ion battery according to claims 20-21, wherein said anti-solvent reduces cathodic limiting potential by at least about 0.1 V.

23. The rechargeable lithium-ion battery according to claims 21-22, wherein said anti-solvent comprises an amide compound.

24. The rechargeable lithium-ion battery according to claim 23, wherein said amide compound comprises urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

25. The rechargeable lithium-ion battery according to claims 20-24, wherein said aqueous electrolyte composition further comprises a hydroxide.

26. A method for increasing an electrochemical stability window in a lithium-ion battery comprising an aqueous lithium electrolyte solution, said method comprising adding an anti-solvent that is miscible with water to said aqueous lithium electrolyte solution.

27. The method according to claim 26, wherein said anti-solvent comprises an amide compound.

28. The method according to claims 26-27, wherein said anti-solvent comprises urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

29. The method according to claims 26-28, wherein said anti-solvent is of the formula:
R¹—C(═O)—NR²R³
wherein
R¹ is C₁-C₄ alkyl, C₃-C₆ cycloalkyl, or a moiety of the formula —X;
X is —OR^{a}, —NR^{b}R^{c}, or —SR^{a};
each of R^{a} is H or C₁-C₄ alkyl; and
each of R^{b}, R^{c}, R², and R³ is independently H or C₁-C₄ alkyl.

30. The method according to claims 26-29, wherein an amount of said electrochemical stability window is increased by at least about 0.2 V.

31. A method for reducing cathodic limiting potential in a lithium battery comprising an aqueous lithium electrolyte solution, said method comprising adding an anti-solvent that is miscible with water to said aqueous lithium electrolyte solution.

32. The method according to claim 31, wherein said anti-solvent comprises an amide compound.

33. The method according to claims 31-32, wherein said anti-solvent comprises urea; N-methyl acetamide; acetamide; N,N-Diethylmethacrylamide; N,N-Dimethylacrylamide; Tetramethylurea; N,N′-Dimethylurea; 1,1-Dimethylurea; 1,3-Diethylurea; 1,1-Diethylurea; or a combination thereof.

34. The method according to claims 31-33, wherein said anti-solvent is of the formula:
R¹—C(═O)—NR²R³
wherein
R¹ is C₁-C₄ alkyl, C₃-C₆ cycloalkyl, or a moiety of the formula —X;
X is —OR^{a}, —NR^{b}R^{c}, or —SR^{a};
each of R^{a} is H or C₁-C₄ alkyl; and
each of R^{b}, R^{c}, R², and R³ is independently H or C₁-C₄ alkyl.

35. The method according to claims 31-34, wherein an amount of cathodic limiting potential is reduced by at least 0.1 V.
